(19) United States
(12) Patent Application Publication
(10) Pub. No.: US 2010/0070372 A1
(43) Pub. Date: Mar. 18, 2010

(54) USING SPAM AND USER ACTIONS TO INFER ADVERTISEMENTS

(75) Inventors: Allie K. Watfa, Urbana, IL (US); Dale Nussel, Mahomet, IL (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 12/212,618

(22) Filed: Sep. 17, 2008

(51) Int. Cl. G06Q 30/00

(52) U.S. Cl. 705/14.68

(57) ABSTRACT

Embodiments are directed towards selecting for display at a client device focused advertisements within a mail message client based on a user's categorization of mail messages, including spam messages. Messages may be classified by a message classifier and placed into different message folders. Actions of the message recipient on the received messages are then monitored and used to determine a spam advertisement factor. If the spam advertisement factor exceeds a threshold for a given message, then the given message may be further examined to determine a focus of the message. The focus may then be used to select an advertisement for display to the recipient.

### TECHNICAL FIELD

The present invention relates generally to managing focused advertisements and, more particularly, but not exclusively to selecting for display at a client device focused advertisements within a mail message client based on a user's categorization of mail messages, including spam messages.

### BACKGROUND

The problem of spam is well-recognized in established communication technologies, such as electronic mail. Spam may include unsolicited messages sent by a computer over a network to a large number of recipients. Spam includes unsolicited commercial messages, but spam has come to be understood more broadly to additionally include unsolicited messages sent to a large number of recipients, and/or to a targeted user or targeted domain, for malicious, disruptive, or abusive purposes, regardless of commercial content. For example, a spammer might send messages in bulk to a particular user to harass, or otherwise, disrupt their computing resources.

However, a sender of a large number of messages might not be considered a spammer. For example, an educational, financial institution, health institution, or the like, might send a large number of messages to its alumni, members, or the like. Similarly, known and/or generally acceptable merchants might send large number of messages that some recipients may actually want to receive. Such bulk message distributors may be well known by some of its recipients, who may actually seek to receive the messages.

For example, a mail recipient might receive a variety of spam or other bulk messages based on something the recipient might have done. For example, the recipient might have signed up for a web site, entered their mail address for a certain purchase, offer, news letter, or the like. Such activities might then result in the recipient receiving such spam and/or other bulk messages. Not all of which, therefore, may be undesired. The recipient may then categorize any of the received mail to be spam, junk private, to be kept, trash, or the like.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a client device that may be included in a system implementing the invention;

FIG. 3 shows one embodiment of a network device that may be included in a system implementing the invention;

FIG. 4 illustrates a logical flow diagram generally showing one embodiment of a process for selectively displaying focused advertisements based on a user's categorization and/or other actions to a received mail message;

FIG. 5 illustrates one embodiment of a screen shot showing a focused advertisement within a messaging client application;

FIG. 6 illustrates one embodiment, of an example of a table of possible weighting values useable in determining a message relevance for use in providing focused advertisements; and

FIG. 7 illustrates another logical flow diagram generally showing another embodiment of a process for selectively displaying focused advertisements based on a analysis of the messages.

### DETAILED DESCRIPTION

The present invention now will be described more filly hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “client” refers to a computer's general role as a requester of data or services, and the term “server” refers to a computer's role as a provider of data or services. In general, it is possible that a computer can act as a client, requesting data or services in one transaction and act as a server, providing data or services in another transaction, thus changing its role from client to server or vice versa.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards selecting for display at a client device focused advertisements within a mail message client based on a user's categorization of mail messages, including spam messages. That is, messages may be classified by a message classifier and placed into different message folders associated with a recipient of the messages. Examples of such message folders include, but are not limited to inbox folders, junk folders, spam folders, delete folders, trash folders, or the like. Actions of the message recipient on the received messages are then monitored. For example, the recipient might select to delete a message in a spam folder, without opening it; might open the message, read it, and then save it in another folder, or delete it. Clearly, a variety of other actions may also be performed by the recipient. In any event, various actions are monitored on the spam messages, junk messages, and similarly classified messages to differentiate between what may be labeled as ‘good’ spam, or accepted spam messages by the recipient, and those messages that may be labeled as ‘bad’ spam or unacceptable messages by the recipient. As used herein, the term ‘spam’ refers to any such message that may be classified, at least initially, as an unsolicited, and/or otherwise undesirable message for a given recipient. Thus, as used herein, junk messages and bulk messages are included within spam messages.

As used herein, the term “folder” refers to any organizational structure usable for categorizing messages. Thus, as used herein the term folder includes “labels” that may be associated with a message to indicate a classification of the message.

A spam relevance rating may be determined using a variety of factors based on the actions performed by the recipient. For example, at least some of the factors include, but are not limited to: did the recipient click on (or otherwise select) the spam message; how much time did the recipient take to read the spam message; how long has a message been in an inbox before being moved; or was the message saved to a private, trash, spam or junk mail folder. In one embodiment, a message sensitivity may also be determined for the message, including, but not limited to whether the message includes adult content, or the like. Based on the spam relevance, a spam advertisement factor may be determined. If the spam advertisement factor exceeds a threshold, then the message may be further examined to determine a focus of the message. Based, at least in part, on the determined focus, an advertisement directed towards the determined focus may be selected and displayed to the message recipient. In one embodiment, the focused advertisement may be displayed within a messaging interface. In one embodiment, the focus advertisement might be displayed next to the recipient's messaging frames.

In this manner, advertisements are anticipated to be more focused towards a recipient, providing an improved and more efficient personalized mechanism for selecting advertisements over such traditional approaches as randomized advertisements. Focused advertisements then may be presented based on received spam messages and how the recipient treated such messages. That is, the more positive attention a recipient might give a message, the more likely that an advertisement related to the spam message will be displayed to the recipient. Thus, the recipient's actions may provide a novel approach to decision making on which advertisements may be more desirable to the recipient. Moreover, a message provider can expose what they are trying to offer to the recipient in a “less” spam-like approach visually and effectively, with a higher likelihood of click-ability by the recipient on the advertisement.

### Illustrative Operating Environment

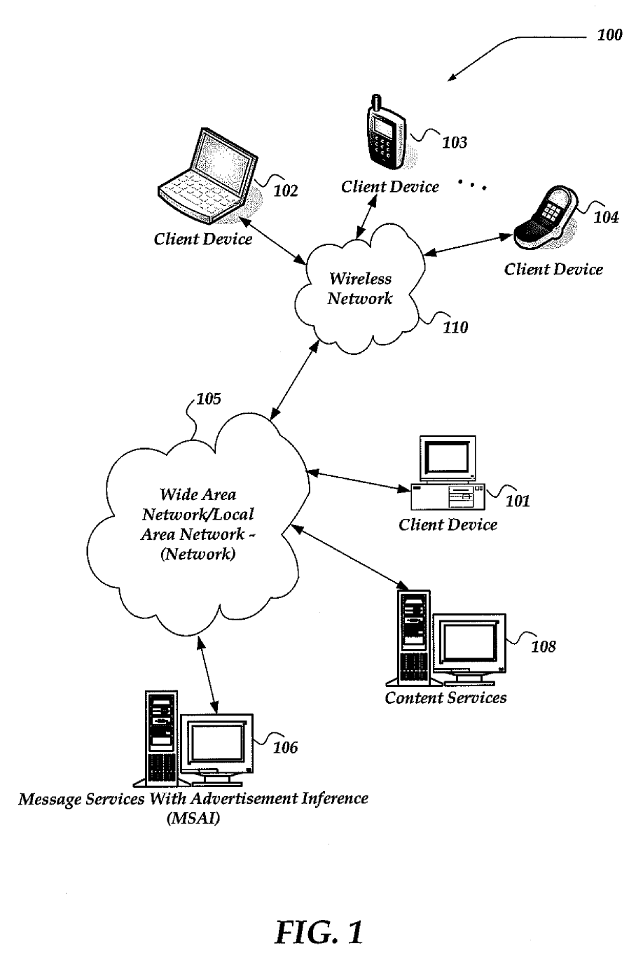

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, client devices 101-104, and content services 108, and Message Services with Advertisement Inference (MSAI) 106.

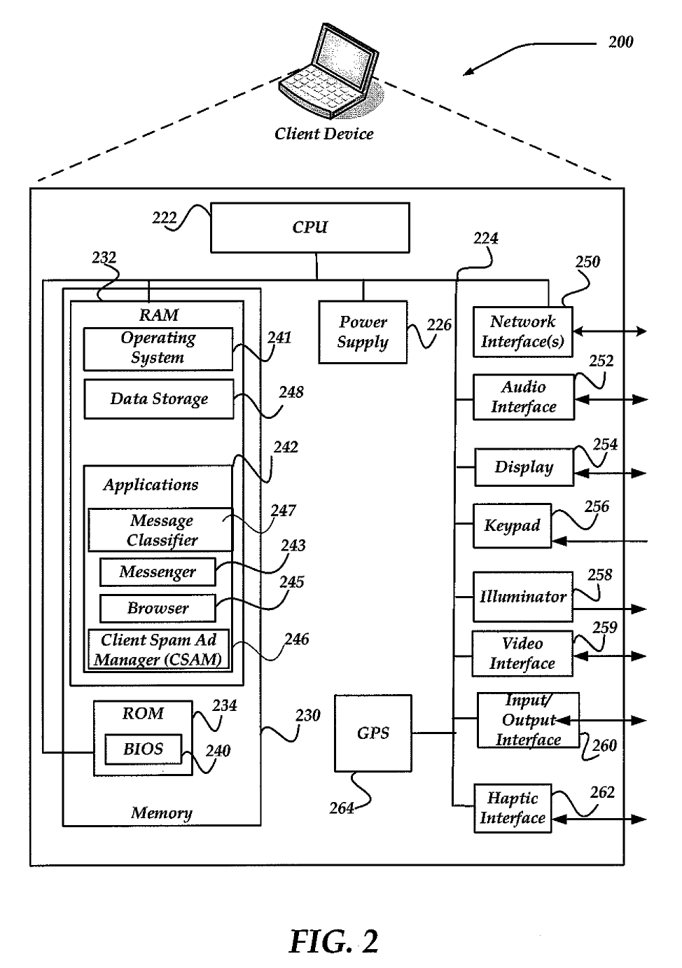

One embodiment of a client device usable as one of client devices 101-104 is described in more detail below in conjunction with FIG. 2. Generally, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device, such as MSAI 106, or the like. Such user account, for example, may be configured to enable the user to receive emails, send/receive IM messages, SMS messages, access selected web pages, or participate in any of a variety of other social networking activity. However, managing of messages or otherwise participating in other social activities may also be performed without logging into the user account.

A user of client devices 101-104 may employ any of a variety of client applications to access content, read web pages, receive/send messages, or the like. In one embodiment, each of client devices 101-104 may include an application, or be associated with an application that resides on the client device or another network device such as MSAI 106, that is useable to classify received messages. In one embodiment, the message classifier might reside remotely on a messaging server, such as MSAI 106, or the like. In one embodiment, the message classifier might perform traditional message filtering to sort messages into one or more message folders, such as an inbox, spam box, junk box, bulk box, or the like, where each of the message folders are associated with one or more messaging clients. Such message filtering typically generates and/or otherwise employs classification data that may be based on a set of rules, policies, or the like, that may be configured for a plurality of client devices, and/or configured for a particular client device/message recipient. The rules, policies, and/or other information used by the classifier might include various classification data including but not limited to keywords, tags, headers, or the like. Messaging clients that employ such message classifiers may include, but are not limited to email clients, IM clients, SMS clients, VOIP clients, or the like.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 10 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple MSAI 106, and client device 101 with other computing devices, including through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

MSAI 106 includes virtually any network computing device that is configured to manage messages received over a network. In one embodiment, MSAI 106 may include a message server that is configured to receive messages and route them to an appropriate client device, or the like. Thus, MSAI 106 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, and the like. However, MSAI 106 may also include a message server configured and arranged to manage other types of messages, including, but not limited to SMS, MMS, IM, or the like.

MSAI 106 may further include one or more message classifiers useable to classify received messages and organize or sort them into different message folders based, in part, on the classification. Such classification may include predictions that the message is a spam message, a bulk message, a ham message, or the like. MSAI 106 may then send the message to a message folder based on the classification.

MSAI 106 may further monitor various actions of a message recipient of the classified messages to determine whether or not a particular action or set of actions indicate that a focused advertisement might be selected for display at a message recipient's client device. Such determinations are described in more detail below.

It should be noted that, while an initial classification of messages and placing of the classified messages into various message folders is described, the invention is not so restricted. Thus, in another embodiment, messages may be initially received into a single folder by the message recipient, virtually unclassified. Actions by the recipient on the messages may still be employed in this embodiment, to determine whether to display to the message recipient a focused advertisement.

Devices that may operate as MSAI 106 include, but are not limited to personal computers, desktop computers, multiprocessor systems, microprocessor-based or programmable consumer electronics, network PCs, servers, network appliances, and the like.

Although MSAI 106 is illustrated as a distinct network device, the invention is not so limited. For example, a plurality of network devices may be configured to perform the operational aspects of MSAI 106. For example, in one embodiment, the message classification may be performed within one or more network devices, while the message server aspects useable to route messages may be performed within one or more other network devices.

Content services 108 represents virtually any network device that may provide content and/or services to a client device, such as client devices 101-104. Such content and/or services, include, but are not limited to social networking content, merchant content, educational content, music content, video content, and the like. As such content services 108 might employ web services, FTP services, messaging services, or the like to provide the content and/or services to a client device. In one embodiment, content services 108 might also be configured to provide bulk messages to various client devices, spam messages, adult content mailings, merchant advertisements, notices, or the like. In one embodiment, such mailings may be based on an action by a recipient, such as signing up for some content and/or service, a received mail address listing that includes the recipient's message address, a browsing activity at content services 108, or the like. Thus, in at least one instance a recipient might view received messages from content services 108 as spam, while another recipient might seek to receive such messages.

Devices that may operate as content services 108 include, but are not limited to personal computers, desktop computers, multiprocessor systems, microprocessor-based or programmable consumer electronics, network PCs, servers, network appliances, and the like.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, r any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like to enable communication with input/output devices, such as a mouse, headset, or the like. This input/output can be visual, audio, tactual, or essentially anything involving one or more of the human senses. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, data files, graphs, videos, or the like. Data storage 248 may further provide storage for user account information useable with one or more message addresses, message folders, or the like. Thus, data storage 248 may include various message storage capabilities to store and/or otherwise manage message folders, such as email folders for spam messages, ham messages, bulk messages, inbox messages, deleted messages, or the like. In one embodiment, data storage 248 may also store and/or otherwise manage message classification data for use by message classifier 247, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, browser 245, message classifier (MC) 247, and Client spam advertisement manager (CSAM) 246.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. In one embodiment, messenger 243 may employ various message boxes or folders to manage and/or store messages.

MC 247 represents a message classifier that is configured to reside on a client device, and to classify messages based on a variety of mechanisms and/or criteria. As used herein, the term “classifier” refers to any of a variety of message organization mechanisms useable to receive messages and to organize the messages based on some defined criteria. As used herein, the classifiers are directed towards organizing a given message based on a determination of whether the message is spam or some other type of message. As such, classifiers referred to herein may also be known as “spam filters.” Such classifiers may employ a variety of mechanisms to make such a determination including, but not limited to examining message headers, from addresses, message routing information, message content (e.g., a message body), a message attachment, or the like.

Message classifiers may employ a variety of approaches to organize messages, including, but not limited to artificial intelligence approaches, various machine learning algorithms, or the like. Non-exhaustive examples include naïve Bayes, Support-Vector machines, logistic regression, perceptrons, Markovian discrimination approaches, neural networks, decision trees, or the like. Further, each of these algorithms may employ different variations, such as regularization, feature weighting, or the like. Non-exhaustive examples of such classifiers include, but are not limited to CRM114 Discriminator, POPFile, DSPAM, SpamAssassin, SpanBayes, or the like. Thus, MC 247 may be used to classify and distribute received messages across a variety of message folders for a recipient.

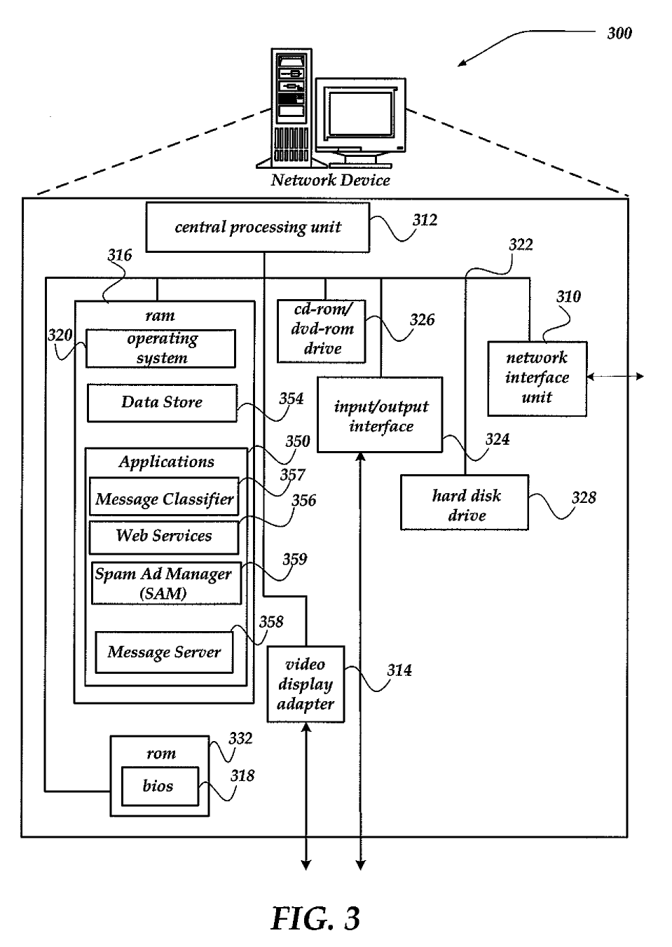

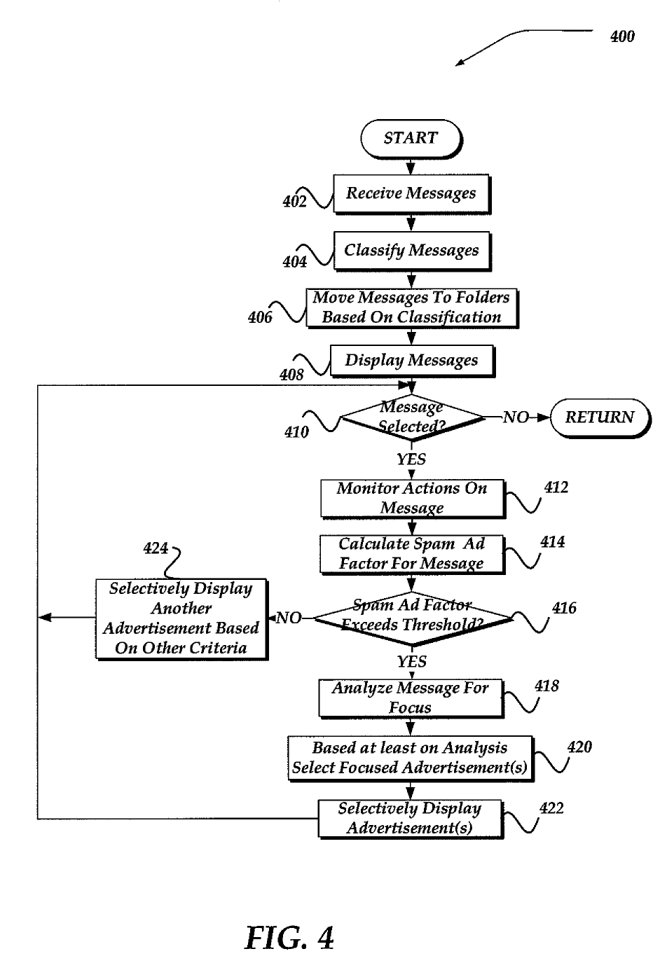

CSAM 246 is configured to monitor actions by a recipient on the received messages, and based on the monitored actions, and/or other information about a message, select for display a focused advertisement. Actions of CSAM 246 are described in more detail below in conjunction with FIG. 4. It should be noted, that while CSAM 246 is illustrated as residing on a client device, the invention is not so limited. Thus, CSAM 246 might be implemented with a network device, such as described below in conjunction with FIG. 3. Similarly, message classifier 247 might also reside within a network device, such as described below in conjunction with FIG. 3. However, multiple message classifiers may also be used, including at least one on client device 200 and/or one or more on network device 300 of FIG. 3.

Moreover, although message classifier 247, messenger 243, and CSAM 246 are illustrated as distinct components, the invention is not so constrained. Thus, one or more of these components may be combined, without departing from the scope of the invention.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, MSAI 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 31 0, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to message folders for a message recipient, classification data useable by message classifier 357, user preferences such as spam advertisement weighting factors, message timers, message content factors, advertisement information, including agreements, or the like, as well as scripts, applications, applets, and the like.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include web services 356, Message Server (MS) 358, message classifier 357, and Spam Advertisement Manager (SAM) 359.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 may interact with message classifier 357, message server 358, and/or SAM 359 when a message is received. Thus, in one embodiment, web services 356 may be employed by a client device to display received messages.

Message server 358 may include virtually any computing component or components configured and arranged to forward messages from message user agents, and/or other message servers, or to deliver messages to a local message store, such as data store 3 54, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

However, message server 358 is not constrained to email messages, and other messaging protocols may also be managed by one or more components of message server 358. Thus, message server 358 may also be configured to manage SMS messages, IM, MMS, IRC, mIRC, or any of a variety of other message types.

In one embodiment, message server 358 and/or web services 356 may enable employ message classifier 357 to organize or sort messages for a user account into message folders based on a message classification. Message classifier 357 represents therefore, at least one message classifier, useable to review messages and to sort the messages into various message folders. In one embodiment, message classifier 357 may initially generate message classification data based on pre-defined rules, procedures, keywords, policies, or the like. For example, in one embodiment, a system administrator might provide information usable as classification data by message classifier 357 indicating that an image is spam based on a keyword, policy, size, or the like. Such information might be pre-loaded into the classification data, which may be stored in a persistent data store, such as on hard disk drive 328, or the like. In another embodiment, message classifier 357 might dynamically modify its classification data based on a client device's messages, however, the resulting classification data remains configured as persistent data reusable a plurality of subsequent times. In another embodiment, message classifier 357 might also receive various inputs about messages from a message recipient, and update message classification data for the given recipient, and/or for other recipients based on the received input. In one embodiment, message classifier 357 operates similar to the message classifier 247 of client device 200. However, in another embodiment, the two message classifiers may operate using different data, algorithms, or the like. However, the intent of each message classifier is to classify received messages such that they may be distributed across one or more message folders for a message recipient.

SAM 359 is configured to monitor actions by a recipient on the received messages, and based on the monitored actions, and/or other information about a message, select for display a focused advertisement. Actions of SAM 359 are described in more detail below in conjunction with FIG. 4. In one embodiment, CSAM 246 of FIG. 2 may be employed instead of SAM 359. However, in another embodiment, CSAM 246 of FIG. 2 might be excluded from client device 200, and SAM 359 may be used instead. However, in yet another embodiment, CSAM 246 and CAM 359 may distribute various actions across each other. Thus, for example, monitoring a recipient's actions on a message, timers, or the like, may be performed by CSAM 246, while a spam advertisement factor calculation, selection of a focused advertisement, or other related actions, might be performed by SAM 359. Other varations are also envisaged.

### Generalized Operation

The operation of certain aspects of the invention will now be described with respect to FIG. 4. FIG. 4 illustrates a logical flow diagram generally showing one embodiment of a process for selectively displaying focused advertisements based on a user's categorization and/or other actions to a received mail message. Process 400 of FIGURE may be implemented within MSAI 106 of FIG. 1 for example, and/or within CSAM 246 of FIG. 2.

As shown, process 400 begins, after a start block, at block 402, where messages may be received for distribution into one or more folders for a message recipient. In one embodiment, the messages are received at a message server, or similar messaging component. In another embodiment, the messages may be received at a client application that may be configured to distribute the messages into one or more message folders. The messages may be from a variety of sources, and/or include a variety of types of messages. For simplicity, consider that the messages are email messages, although the invention is not so limited.

Process 400 may then flow to block 404, where the messages may be classified using any of a variety of mechanisms, including, but not limited to those described above. Such classifications might result in some messages be classified as acceptable for distribution into an inbox folder, while other messages might be classified as spam messages, junk messages, messages for trash, bulk messages, or the like. Such classifications may be based on a message content, a message source, a message header, message size, or the like. In one embodiment, a message sensitivity may be determined for at least some of the messages, including, for example, whether the message includes or is otherwise associated with adult content.

Processing continues to block 406, where the classified messages are then distributed to various message folders based on their classification. Continuing to block 408, the messages may be made available to a message recipient for selection, and/or display, moving, or the like. In one embodiment, the display of the messages might be similar to that of traditional email client applications, wherein a message header might be displayed within a list of messages for a given message folder. In another embodiment, a recipient might have configured their message client application to enable a preview of messages within a preview frame of their message client application. In any event, the messages are made available for the recipient to manage. In one embodiment, various timers may be initiated to determine how long a message remains within a given message folder before the message recipient selects the message to perform some action upon the message, including, but not limited to moving the message, deleting the message, reading the message, or the like.

Moving to decision block 410, a determination is made whether the message recipient has selected a message from within one of the message folders. Selection may be detected based on a clicking of a displayed message header for a message, such as a subject line displayed within the message client application, or the like. If a message is determined to have been selected, processing flows to block 412; otherwise, processing may return to a calling process to perform other actions.

At block 412, additional actions on the message may be monitored. For example, actions such as whether the recipient reads the selected message, moves the selected message to another folder, deletes the message either without reading it, or deletes the message after having read it, and/or combinations of the above, as well as any of a variety of other actions.

Processing flows next to block 414, where a spam advertisement factor may be determined for the message. The spam advertisement factor may be based on a variety of factors determined from the recipient's actions, and/or information about the message. Thus, in one non-limiting embodiment, the spam advertisement factor may be based on the following:
Was the message a spam message and was it clicked on by the recipient? (herein called “clickedon”);
How much time did the recipient spend reading the message? (herein called “timespent”);
How long was the message in the inbox folder before it was moved, or selected? (herein called “timeinfolder”);
A sensitivity of the message (such as is it adult content). (herein called “isadult”); and
Was the message saved on to a trash, or junk mail folder? (herein called “istrash,” and “isjunk,” respectively).

Clearly, other spam relevance factors may also be considered. Thus, the invention is not limited by the above example factors. In one embodiment, the spam advertisement factor the message may then be determined as:

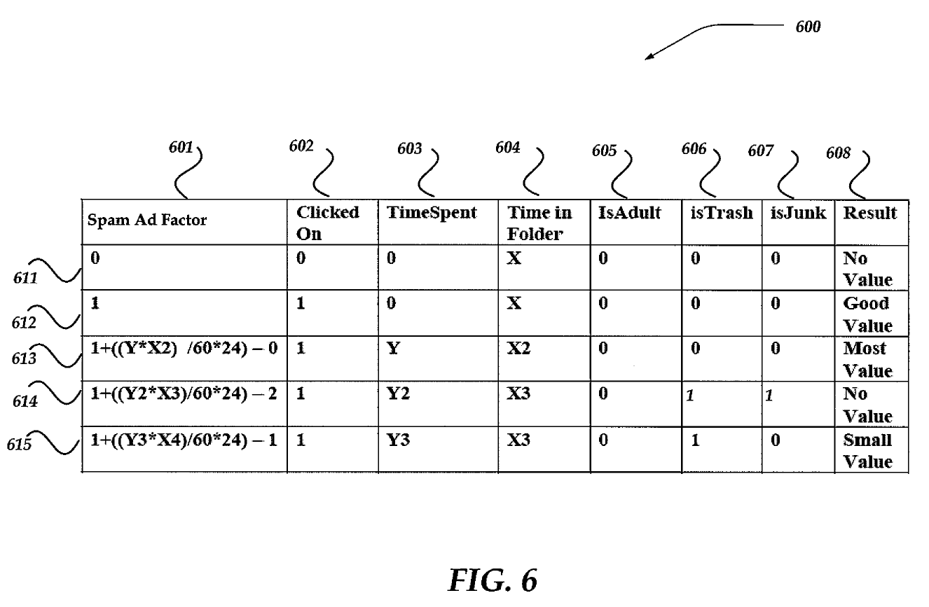

Spam advertisement factor=clickedon+((timespent*timeinfolder)/wa)−(wb*isadult+wc*istrash+wd*isjunk), wherein wb, wc, and wd are weighting factors, and wa is a conversion factor. Where timespent and timeinfolder are measured in seconds, wa may equal 60*24 or 1440. In one embodiment, wb, wc, and/or wd may be equal to values between −1 and +1. In one embodiment, wb, wc, and/or wd may be modifiable by the recipient. For example, initially, wb might be set to 1, indicating that adult content is undesired for this recipient. However, the recipient might actually seek to receive such content. Thus, in one embodiment, the recipient might be enabled to modify the weighting factor wb to another value, such as −1, or the like, to enhance a likelihood that focused advertisements of adult content are received by the recipient. In any event, examples of computations of spam advertisement factors are discussed in more detail below in conjunction with FIG. 6. In one embodiment, clickedon, isadult, istrash, and/or isjunk may be represented by discrete values, such as zero (e.g. not clicked on), or one (e.g., clicked on).

Flowing to decision block 416, a determination is made whether the spam advertisement factor is above a defined threshold, which may be set based on engineering judgment, statistical analysis, an objective to minimize an amount of advertisement to the recipient, and/or a variety of other criteria. If it is determined that the threshold is exceeded, processing flows to block 418; otherwise processing flows to block 424.

Block 424 is an optional block. In one embodiment, at block 424, some other advertisement might be displayed to the recipient based on some other criteria. For example, in one embodiment, advertisements might be displayed based on other non-message actions by the recipient, such as actions performed during web browsing, searching, or the like. In another embodiment, other advertisements might be selected for display based on an agreement with the recipient, an agreement with a merchant, or other advertiser, or the like. In still another embodiment, at block 424, it may be determined that no advertisement will be displayed. In any event, processing may then loop back to decision block 410.

At block 418, the message may be analyzed to determine its focus. For example, the content of the message may be analyzed to determine a subject matter of the message. In one embodiment, a message source might be analyzed to determine a subject matter for which the message source may be associated with. Then, flowing to block 420, an advertisement directed toward the determined focus of the message is selected. In one embodiment, such selection might include requesting that an advertiser associated with the focus subject matter provide an advertisement focused to the subject matter. In another embodiment, advertisers may bid on placement for their advertisement based on the focused subject matter. In any event, moving next to block 422, the selected focus advertisement may be displayed to the recipient. In one embodiment, the focus advertisement may be displayed along with or within a messaging interface. In another embodiment, the focus advertisement might ‘float’ in a separate window above, in a corner of, or within a client display. The recipient may subsequently click on the focus advertisement, select to have the focus advertisement to no longer be displayed, or otherwise ignore the focus advertisement. In one embodiment, the displayed focus advertisement might appear at once after the recipient performs an action on the message. In another embodiment, the focus advertisement might be displayed at a next action by the recipient, when the recipient next logs into the messaging client, based on some time event, or any of a variety of other criteria. In any event, processing may then loop back to decision block 410.

Even though a single loop is indicated in FIG. 4, blocks 418, 420, and 422 could be done after a pre-determined number of loops or after all loops are exhausted for a given set of messages. That is, in another embodiment, process 400 may perform blocks 418, 420, and 422 may be performed after a user has signed off, performed some action on a predetermined number of messages, or even after some period of time of inactivity within the messaging application is detected. After such event(s), blocks 418, 420, and 422 may then be performed potentially over a larger set of messages than for each message selected.

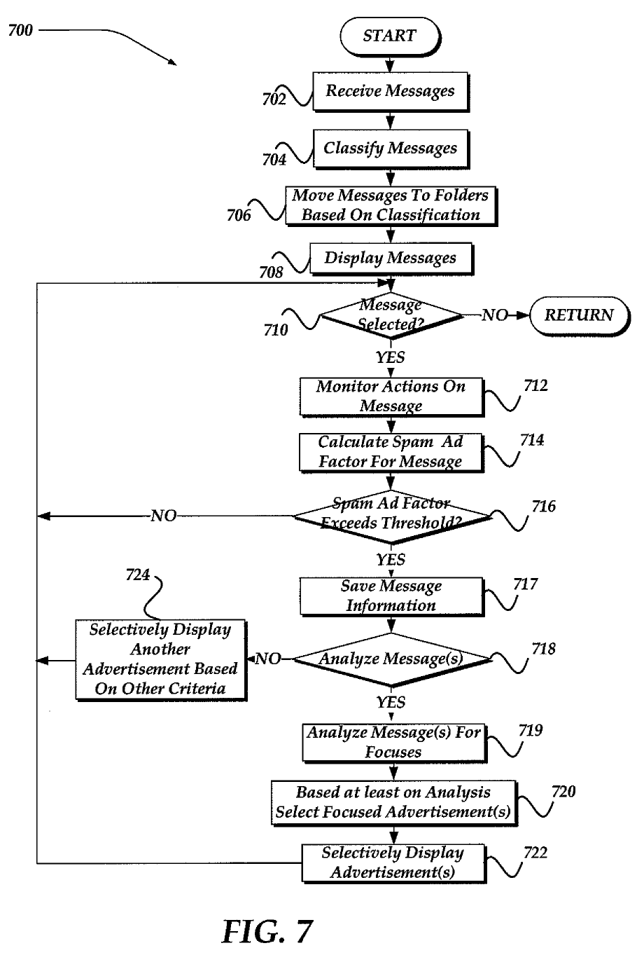

FIG. 7 illustrates another logical flow diagram generally showing another embodiment of a process for selectively displaying focused advertisements based on a analysis of the messages. As may be noticed block 702 through block 716 are substantially the same as described above for block 402 through block 416 of FIG. 4.

However, at decision block 716 if the spam ad factor exceeds the threshold, processing for process 700 flows to block 717 wherein information about the message may be saved, for later analysis. This may also be achieved by adding a pointer or the like to an index, the message, or the like. In any event, processing then continues to block 718, where a determination is made whether to analyze the saved message information. The decision to perform the analysis may be based on any of a variety of criteria, including, but not limited to those mentioned above. In any event, if analysis is not to be performed, processing flows to block 724, which is substantially equivalent to block 424 of FIG. 4. If analysis is to be performed, processing flows to block 719 where a plurality of messages may be analyzed for their respective focus, as described above in block 418. Processing then flows to block 720, wherein advertisements are selected for display, and then to block 722 where the messages are selectively displayed. Processing may then loop back to decision block 710.

At decision block 716, if the spam ad factor did not exceed the threshold, processing returns to decision block 710. Furthermore, at decision block 718, if analysis is not to be performed, in one embodiment, block 724 may be optionally performed, substantially as described above for block 424.

By performing such analysis of messages less often, efficiency may be improved, as well as enabling other actions to be performed. For example, in one embodiment, each of the messages may be analyzed for their focus, commonly focused messages may be managed collectively. For example, consider that several messages have a common focus on car purchases. Then rather than displaying several advertisements for car purchases, a single advertisement focused on car purchases might be displayed. However, the invention is not limited to merely displaying a single advertisement based on commonly focused messages. Thus, in another embodiment, such commonly focused messages may be used to determine a rank ordering of focused advertisements. For example, consider where the user selected, say 20 car purchase messages, and, say 12 restaurant related messages. In this, non-limiting, non-exhaustive example, then car purchase advertisements might be ranked higher than restaurant related advertisements. Using the ranking, advertisements may then be displayed based on the ranking. For example, the car purchase advertisements might be shown to the user before the restaurant related advertisements. In another embodiment, the car purchase advertisements might be displayed to the user for a longer time period, more frequently over time, or the like, over those advertisements for restaurants. Thus, by collectively analyzing the messages, a plurality of different display options may be selected. The invention therefore, is not limited to those mentioned above, and others are envisaged as well.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Illustrative Non-Limiting, Non-Exhaustive Examples

The following describes non-limiting, non-exhaustive examples useable to illustrate various aspects of the invention. The invention is not to be construed as being limited by, or otherwise constrained by, such examples, and other examples, implementations, and variations may also be employed without departing from the scope of the invention.

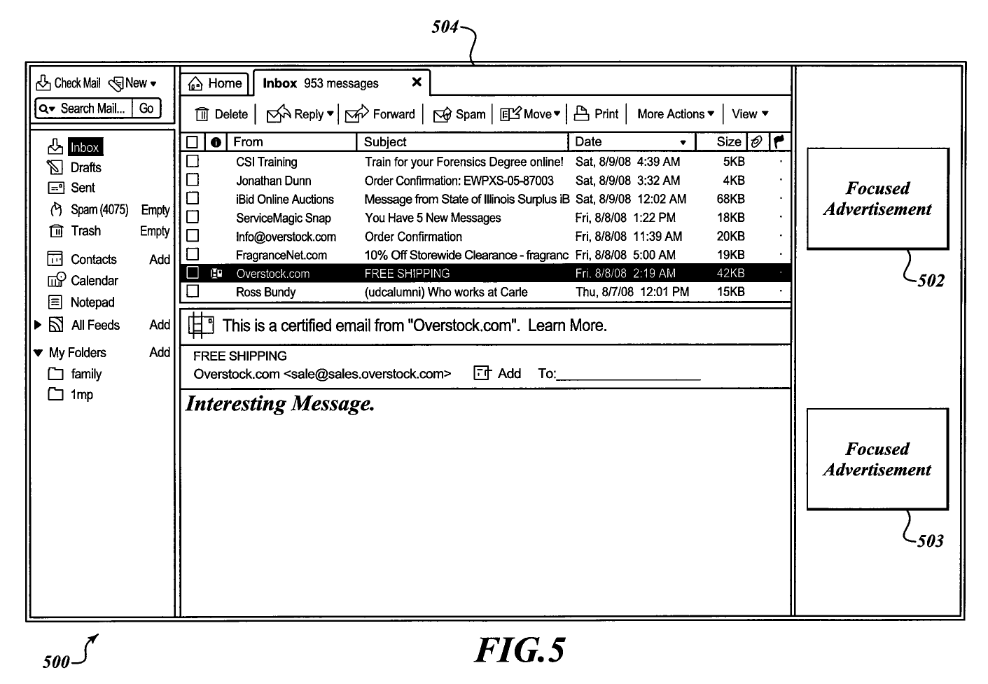

In any event, FIG. 5 illustrates one embodiment of a screen shot showing a focused advertisement within a messaging client application. Screen 500 represents one non-limiting, non-exhaustive example of a possible display at a client device of focused advertisements 502-503 with a messaging client interface 504. In one embodiment, several focused advertisements 502-503 may be displayed. However, the invention is not so limited. For example, in another embodiment, a single focused advertisement might be displayed. Moreover, a display of the focused advertisements might be such that a display of any one focused advertisement is timed for some defined time, and then another focused advertisement might replace the prior displayed focused advertisement. Similarly, focused advertisements 502-503 might appear below messaging client interface 504, and/or above messaging client interface 504. Thus, the invention is not limited by a particular placement of the focused advertisement, and/or other display aspects of the focused advertisement(s).

Thus, for example, where there may be a partnership with an advertiser, a selection of the focused advertisements might be further influenced. Consider where, for example, there is an agreement with FORD motor company. When the recipient receives a spam message from an automotive company, and selects to read, and/or keep the message, a focused advertisement might be specifically selected from advertisements provided by the FORD motor company.

FIG. 6 illustrates one embodiment, of an example of a table of possible weighting values useable in determining a message relevance for use in providing focused advertisements. As shown table 600 includes a plurality of rows 611-615 which represent several possible examples of spam advertisement calculations. It should be noted that rows 611-615 are not intended to be an exhaustive representation of all possible combinations of calculations, but merely represents some of the possible calculations. Thus, the invention is not to be limited by such table 600 example.

As shown, spam advertisement factors (column 601) may be determined based on values for clickedon 602, timespent 603, timeinfolder 604, isadult 605, istrash 606, and isjunk 607. Column 608 represents possible outcome analysis for a given calculation.

Thus, row 611 represents where the message might have resided in the inbox folder for X time, before an action is taken, such as deleting the message, moving the message, or the like—that may involve other than clicking on the message, which results in opening the message for viewing. As shown, such result would indicate that no actual value is attributed to the message. That is, the spam advertisement threshold for row 611 would be zero. The message may, in one embodiment, be determined not to have a spam advertisement factor above a given threshold, such that a focused advertisement might be selected based on that message.

In row 612, the message is identified as having been clicked on for viewing. The result is that the message might have a good spam advertisement factor that may exceed the threshold. In this instance, a focused advertisement may be selected for the message.

In row, 613, additional actions are observed for the message, including that the recipient spent Y seconds reading the message. Thus, this message may also have a spam advertisement factor that exceeds the threshold, resulting in a focused advertisement being selected based on the message.

In row 614, the message, although it was clicked on, and read, it was then moved to trash and to a junk folder. Therefore, the message would have a spam advertisement factor below the threshold, resulting in no selection of a focused advertisement. Similarly, with respect to row 615, the message may have been clicked on, and time Y3 spent reading the message, but the message was moved to trash. Thus, the message may also have a spam advertisement factor below the threshold. Thus, no focused advertisement is likely to be displayed.

It should be noted, however, that in row 615, the threshold might be lowered such that focused advertisements may be selected for that message. Thus, based on a threshold value, messages may selectively be used to generate focused advertisements.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device to manage a delivery of a message over a network, comprising:
a transceiver to send and receive data over a network; and
a processor that is operative to perform actions, comprising:
displaying a plurality of messages, each message being located in one of a plurality of message folders that include at least an inbox folder and a spam folder;
monitoring actions performed on a message;
calculating a spam advertisement factor based on the monitored actions performed on the message; and
if the spam advertisement factor exceeds a threshold value:
determining an advertisement associated with at least a content of the message, and
displaying the advertisement within a messaging interface.

2. The network device of claim 1, wherein monitoring actions further comprises monitoring at least one of if the message is selected, a time the message is determined as being read, a duration in which the message is in a folder, a sensitivity of the message, or whether the monitored action resulted in moving the message from one folder to another folder.

3. The network device of claim 1, wherein calculating the spam advertisement factor further comprises:
determining a time spent in one folder before the message is moved to another folder;
determining a time the message is being read;
determining if the message includes adult content;
determining if the message is moved to a trash folder or junk folder; and
calculating the spam advertisement factor by combining the time the message is being read with the time spent in one folder, and subtracting weighted values based on if the message includes adult content or is moved to the trash folder or the junk folder.

4. The network device of claim 1, wherein determining an advertisement further comprises:
analyzing a content of the message;
selecting an advertiser based on the content analysis; and
obtaining the advertisement based on the advertiser selection.

5. The network device of claim 1, wherein displaying the advertisement further comprises displaying the advertisement for a defined period of time, and then switching to either displaying another advertisement or displaying no other advertisement.

6. A processor readable storage medium that includes data and instructions, wherein the execution of the instructions on a computing device provides for managing messages by enabling actions, comprising:
displaying at a client device a plurality of messages, each message being located in one of a plurality of message folders that include at least an inbox folder and a spam folder;
monitoring actions performed on a message by a user of the client device;
calculating a spam advertisement factor based on the monitored actions performed on the message; and
if the spam advertisement factor exceeds a threshold value:
determining an advertisement relevant to the message, and
displaying the advertisement at the client device; and
if the spam advertisement factor is less than the threshold value, selecting to display an advertisement based on another criteria.

7. The processor readable storage medium of claim 6, wherein the plurality of messages are located into a message folder based on executing a spam message filtering of the plurality of messages.

8. The processor readable storage medium of claim 6, wherein the monitored actions further comprises a time a message is located in a message folder before a user action on the message is detected.

9. The processor readable storage medium of claim 6, wherein calculating the spam advertisement factor further comprises:
receiving at least one user-selectable weight that is applicable to at least one factor within the calculation of the spam advertisement factor, wherein the at least one factor includes at least one of an indicator of whether the message includes adult content, whether the message is located or otherwise moved to a trash folder or a junk folder.

10. The processor readable storage medium of claim 6, wherein determining the advertisement relevant to the message further comprises:
analyzing a content of the message to identify a possible subject of the advertisement; and
selecting the advertisement for display based on content analysis.

11. The processor readable storage medium of claim 6, wherein calculating the spam advertisement factor further comprises:
determining if the message is selected by the user;
determining a time the message is located in an inbox folder before being moved or otherwise acted upon by the user;
determining a time the message is detected as being read by the user;
determining a classification of the message as being trash, including adult content, or is junk; and
calculating the spam advertisement factor by combining each of the above determinations.

12. A method for managing a message delivery, comprising:
displaying within a messaging interface a plurality of messages, each message being located in one of a plurality of message folders that include at least an inbox folder and a spam folder;
monitoring actions performed on a message within the plurality of messages;
determining a spam advertisement factor based on the monitored actions performed on the message; and
selectively displaying an advertisement related to the message based on the determined spam advertisement factor exceeding a threshold value.

13. The method of claim 12, wherein monitoring actions further comprises:
monitoring for at least one of whether a message in the spam folder is selected, an amount of time in which the message in the spam folder is determined to be read, a duration in which the message is in a first folder before being moved to a second folder, a message sensitivity classification, and a message folder in which the message is moved.

14. The method of claim 12, wherein determining a spam advertisement factor further comprises:
determining values for the following:
whether the message is selected (clickedon),
a time the message is detected as being read (timespent),
a time the message is in a folder before moved to another folder (timeinfolder),
whether the message includes adult content (isadult),
whether the message is classified as trash or is moved based on a monitored action to a trash folder (istrash), and
whether the message is classified as junk or is moved based on a monitored action to a junk folder (isjunk); and
determining the spam advertisement factor based on:
clickedon+((timespent*timeinfolder)/wa)−(wb*isadult+wc*istrash+wd*isjunk), wherein wa, wb, wc, and wd are weighting factors.

15. The method of claim 12, wherein selectively displaying an advertisement further comprises:
if the spam advertisement factor exceeds the threshold:
analyzing at least a content of the message;
selecting the advertisement based on the content analysis; and
displaying the selected advertisement to a user.

16. The method of claim 12, further comprising:
employing a message classifier to classify each message in the plurality of messages, wherein the message classifier is configured to modify a message classification based in part on a user action upon a message within the plurality of messages.

17. A system for enabling a communications over a network, comprising:
a messaging interface that is configured to display a plurality of messages, each message being located in one of a plurality of message folders; and
a spam advertisement manager that is configured to perform actions, including:
monitoring user actions performed on a message within the plurality of messages;
determining a spam advertisement factor based on the monitored actions performed on the message; and
selectively displaying an advertisement related to a content of the message based on the determined spam advertisement factor exceeding a threshold value.

18. The system of claim 17, wherein monitoring user actions performed on the message further comprises detecting the message being moved from one message folder to another message folder based on the monitored user actions.

19. The system of claim 17, wherein determining a spam advertisement factor further comprises determining values for at least one of the following: whether a message in a spam message folder is selected, an amount of time in which the message in the spam folder is determined to be read, a duration in which the message is in a first message folder before being moved to a second message folder, whether the message is detected to include adult content, and a value indicating if the message is moved to a trash message folder or a junk message folder.

20. The system of claim 17, wherein selectively displaying the advertisement further comprises:
if the spam advertisement factor exceeds the threshold value:
determining a subject matter of the message,
selecting an advertiser based in part on the determined subject matter, and
receiving from the advertiser an identification of the advertisement, and
displaying the identified advertisement with the messaging interface at a client device.
